(19) United States
(12) Patent Application Publication
(10) Pub. No.: US 2025/0022620 A1
(43) Pub. Date: Jan. 16, 2025

(54) Molten Salt Nuclear Reactor of the Fast Neutron Reactor Type, Having a Design of the Primary Circuit Allowing Exploitation which is Versatile in Terms of Fuel and Mode of Operation

(71) Applicant: COMMISSARIAT A L'ENERGIE ATOMIQUE ET AUX ENERGIES ALTERNATIVES, Paris (FR)

(72) Inventors: Guillaume CAMPIONI, Paris (FR); Vincent PASCAL, Vinon Sur Verdon (FR); Antoine GERSCHENFELD, Montrouge (FR); Yannick GORSSE, Gif Sur Yvette (FR)

(73) Assignee: COMMISSARIAT A L'ENERGIE ATOMIQUE ET AUX ENERGIES ALTERNATIVES, Paris (FR)

(21) Appl. No.: 18/542,937

(22) Filed: Dec. 18, 2023

(30) Foreign Application Priority Data
Dec. 19, 2022 (FR) 22 13883

(51) Int. Cl. G21C 1/03; G21C 3/54; G21C 11/06; G21C 15/243; G21C 15/26

(52) U.S. Cl. CPC G21C 1/03; G21C 3/54; G21C 11/06; G21C 15/243; G21C 15/26

(57) ABSTRACT

A molten salt nuclear reactor of the fast neutron reactor type may be designed as a cylindrical shell in the reactor vessel free of moderator or at the very least of a moderator enabling a reactor to be qualified as a thermal neutron reactor, which may make it possible to effectively separate the fluid zones between those delimited at its periphery in which the heat exchanger(s) exchanging heat between primary and secondary circuit is (are) arranged and the zone inside the shell of which the bottom defines the reactor core within which the nuclear fission chain reactions occur, and a neutron reflector at the periphery of the core makes it possible to use a plurality of types of fuel liquid.

### TECHNICAL FIELD

The present invention relates to the field of molten salt nuclear reactors or MSRs (Molten Salt Reactors). More particularly, it relates to the field of so-called low or medium power MSRs, also known as AMRs (Advanced Modular Reactors).

Thus a main objective of the invention is to adapt the design of the primary circuit of such reactors, more particularly those of the fast neutron reactor type, to allow great versatility both in terms of fuel (uranium, plutonium, thorium, minor actinides) and mode of operation (burner or breeder).

Here and in the context of the invention a “molten salt reactor” is to be understood in the usual technological sense, namely to mean a nuclear reactor in which the nuclear fuel is in liquid form, dissolved in a molten salt, at a temperature typically comprised between 500 and 900° C., which salt acts as a coolant.

### PRIOR ART

Molten salt reactors rely on the use of a molten salt, for example lithium fluoride (LiF) and beryllium fluoride (BeF2), or else sodium chloride (NaCl) and magnesium chloride (MgCl2), which act both as coolant and as moderator by way of primary fluid within the reactor vessel, which is made of metal or a ceramic such as SiC.

The vessel contains the molten salt at a high temperature, typically of between 50° and 900° C., generally at ambient pressure.

The fissile fuel may be uranium 235, plutonium or uranium 233, the latter then being derived from the conversion of thorium. A molten salt reactor may be a self-sustaining breeder reactor having its own breeding blanket containing the fertile isotope that is to be irradiated.

The nuclear reaction is triggered by the concentration of fissile material of the fuel within the reactor vessel, by the geometry or else by the materials present within the critical zone, for example a graphite moderator unit.

A molten salt reactor can therefore be moderated using graphite, producing thermal neutrons, or without a moderator, producing fast neutrons.

It is thus the presence or absence of moderators that defines the two broad families of molten salt reactor, namely thermal neutron reactors and fast neutron reactors respectively.

From around the year 2000 onwards, molten salt reactors have been evaluated and then adopted as part of the Generation IV International Forum. They have since undergone research with a view to deploying them as generation-IV reactors, notably as small modular reactors (SMR) which are advanced nuclear reactors (AMR) with a power capacity that may extend up to 300 MWe per unit: [1].

In theory, molten salt fast neutron reactors offer the advantage of great versatility both in terms of the fuel that can be used (uranium, plutonium, thorium, minor actinides) and in terms of their mode of operation (burner or breeder).

It is recalled here that a “burner” mode corresponds to reactor operation in which there is intensive consumption of the fissile isotopes with limited breeding of fissile material.

For a nuclear reactor, a “breeder” mode is operation whereby the reactor uses fertile material to produce all or some of the fissile fuel that it consumes. Thus, neutrons generated by fission in the reactor core are absorbed by a fertile material which in turn produces new fissile products.

In burner mode, a molten salt fast neutron reactor may use, by way of fissile isotopes: uranium 235, uranium 233, the fissile isotopes of plutonium and the fissile isotopes of the minor actinides.

In breeder mode, a molten salt fast neutron reactor may use the same fissile isotopes as are listed above and, by way of fertile isotopes, may use: uranium 238, thorium 232, the fertile isotopes of plutonium and the fissile isotopes of the minor actinides.

Hitherto, however, no design has exploited the above-mentioned huge versatility of molten salt fast neutron reactors.

There is therefore still a need to improve reactors of the fast neutron molten salt reactor type, particularly when these are being envisioned by way of SMRs, in order to exploit the great versatility both in terms of fuel which can be employed and mode of operation (burner or breeder).

The aim of the invention is therefore to at least partially meet this need.

### DISCLOSURE OF THE INVENTION

In order to achieve this, one of the aspects of the invention relates to a molten salt nuclear reactor, of the fast neutron reactor type, comprising:
a reactor vessel exhibiting symmetry of revolution about a central axis, internally delimiting a primary circuit for fuel in liquid form and in which vessel at least one salt is melted, the inside of the vessel being free of a moderator material;
at least one heat exchanger exchanging heat between the primary reactor circuit and a secondary circuit and arranged inside the reactor vessel;
a first shell in the form of at least one hollow cylinder of central axis coincident with that of the reactor vessel, the first shell being arranged in the reactor vessel in order to divide the interior thereof into a central zone and a peripheral zone in which the heat exchanger is arranged so that when the reactor is in operation, the molten salt fuel liquid circulates via natural convection in a loop from the bottom of the central zone defining the reactor core in which the fission reactions occur, from where it rises, as a result of heating, as far as the top of the central zone where it is deflected towards the top of the peripheral zone to pass through the exchanger then drops back down towards the bottom of the peripheral zone where it is deflected towards the core of the reactor;
a neutron reflector, arranged at the periphery of the core against the reactor vessel, in order to maintain the neutron flux in the core.

In the context of the invention what is meant by “free of any moderator material” is any material that allows a nuclear reactor to be qualified as a thermal neutron nuclear reactor. In the usual sense, the kinetic energy of a fast neutron is in excess of 1 eV, whereas that of a thermal neutron is lower than 1 eV, typically of the order of 0.025 eV. Reference may be made to publication [3], and in particular FIG. 4, which, for various types of reactor, indicates the thermal fraction and the fast fraction of the neutron flux.

Thus, a molten salt reactor according to the invention is qualified as a fast neutron reactor. Typically, a molten salt reactor according to the invention may exhibit a thermal neutron fraction ranging from 0 to 0.05 and a fast fraction ranging from 0.6 to 0.65.

The material of a neutron reflector according to the invention can be selected from a graphite, a silicon carbide, MgO, nickel, stainless steel or tungsten.

According to a first alternative,
the molten salt fuel liquid of the primary circuit is a mixture of NaCl—UCl3, preferably in proportions ranging from 25 to 30 mol % for the UCl3, and of PuCl3, preferably in proportions ranging from 5 to 36 mol %, by way of salts, with depleted uranium,
that part of the first shell that is arranged above the exchanger(s) is a cylinder ring closed on itself, while that part that is arranged below the exchanger(s) is a hollow cylinder,
the neutron reflector is made of silicon carbide (SiC).
the molten salt fuel liquid of the primary circuit is a mixture of NaCl—UCl3, preferably at a content of 34 mol %, by way of salt, with enriched (HALEU) uranium U235, preferably in proportions ranging from 5 to 20%.
the first shell is a cylinder ring closed on itself,
the neutron reflector is graphite.

According to another advantageous embodiment, the nuclear reactor comprises a second shell arranged concentrically inside the first shell so as to guide the rising fuel liquid between the two zones at which it is deflected.

According to this embodiment, the inside of the second shell advantageously defines a space inside which nuclear-reaction control and/or safety rods extend. In other words, this second shell forms an open-ended column arranged coaxially inside the first shell and at the centre of the reactor vessel. This central column advantageously makes it possible to direct the ascending fuel liquid thus guided into the annular space between the first and second shells, and create space for control and/or safety rods.

As a preference, the outside diameter of the second shell is comprised between 5 and 30% of the inside diameter of the first shell.

As a further preference, the first shell and, where applicable, the second shell is (are) fixed by being suspended from the core head plug that closes the reactor vessel. The first shell and, where applicable, the second shell is (are) preferably made of a stainless steel.

In the context of the invention, the core head plug may be supported by or formed integrally with the reactor closure slab that forms the upper part of the reactor pit.

According to another advantageous embodiment, the reactor comprises at least one deflector, preferably in the form of a portion of a torus, arranged below and/or above the first shell so as to distribute the flow of the deflected molten salt fuel liquid. In other words, this (these) toric deflector(s) make it possible to optimize the distribution of the flow of the fuel liquid within the reactor vessel. The deflector(s) is (are) preferably made of a stainless steel.

According to another advantageous embodiment, the reactor vessel comprises a cover gas plenum, usually termed a reactor pile cover gas plenum, filled with an inert gas, such as argon, on top of the molten salt fuel liquid. This cover gas plenum makes it possible to absorb the thermal expansion of the fuel salt liquid within the reactor vessel as it experiences a variation in level.

According to one advantageous structural variation, the heat exchanger(s) comprises (comprise) a bundle of tubes, of the bayonet tube type, with hollow tubes each opening into a blind tube, which defines the part for exchange with the secondary circuit, plunged substantially vertically at least partially into the molten salt fuel liquid, the open-ended hollow tubes being connected to an inlet manifold and the blind tubes being connected to an outlet manifold for the secondary fluid.

Advantageously, the inlet and outlet manifolds for the secondary fluid are arranged in the reactor pile cover gas plenum. With such an arrangement, direct contact between these manifolds and the salt of the primary circuit is avoided, thereby increasing their life and the operational dependability of the exchangers, since the only submerged part is just part of the height of the tube bundle.

The nuclear reactor may exhibit one and/or another of the following dimensional characteristics for a power typically of 150 MWth:
the inside diameter of the reactor vessel is comprised between 1.5 and 2 m;
the height of the primary circuit inside the reactor vessel is comprised between 2.5 and 4 m.

When the reactor is in operation, the temperature of the molten salt fuel liquid of the primary circuit may be comprised between 500 and 900° C.

As a preference, the secondary fluid circulating in the exchanger(s) is based on a mixture of molten salts NaCl—MgCl₂, NaCl—MgCl₂—KCl or else NaCl—MgCl₂—KCl—ZnCl₂.

Advantageously, the temperature of the secondary fluid entering the exchanger(s) is of the order of 550° C., while its temperature on leaving the exchanger(s) is of the order of 600° C.

The power of the nuclear reactor is advantageously below 300 MWth, which corresponds to a power range sought for reactors of SMR type.

Thus, the invention essentially consists in creating a molten salt nuclear reactor of the fast neutron reactor type, the design of which is that of a cylindrical shell in the reactor vessel free of moderator or at the very least of a moderator enabling a reactor to be qualified as a thermal neutron reactor, which makes it possible to effectively separate the fluid zones between those delimited at its periphery in which the heat exchanger(s) exchanging heat between primary and secondary circuit is (are) arranged and the zone inside the shell of which the bottom defines the reactor core within which the nuclear fission chain reactions occur, and a neutron reflector at the periphery of the core makes it possible to use a plurality of types of fuel liquid.

It is advantageously possible to use a single exchanger, which is to say one having a single outlet for exchange with the secondary circuit.

This shell thus makes it possible to ensure the circulation of the primary liquid which contains a chloride salt and uranium/plutonium fuel solely through natural convection within the reactor vessel.

When the reactor is in operation, the molten salt liquid at the cold temperature leaving the exchanger drops down at the periphery of the core, changes direction at the bottom of the vessel at a lower turning zone, which turning may preferably be brought about by a deflector with a toric partial cross section, then rises up through the central part of the core, becoming hotter.

With the hot temperature it has acquired, the molten salt liquid continues to rise up as far as a level above the exchanger and is then returned to this exchanger by an upper turning zone, the turning preferably being brought about by a deflector with a toric partial cross section.

Ultimately, a molten salt fast neutron nuclear reactor according to the invention offers numerous advantages including:
circulation solely by natural convection for the primary circuit with the possibility of employing a single exchanger between the primary and secondary circuits;
simplification of the fluid circuits by comparison with the solutions of the prior art, notably with the elimination of all the pipework and pumps required in the MSFR designs cited in the preamble;
the possibility of dimensioning a reactor vessel incorporating a primary fuel circuit that is reduced in size, typically having a diameter of less than 2 m, and an overall height of less than 4 m, rendering the reactor compliant with the requirements of modular reactors of the SMR type. Thus, a primary circuit with a reactor vessel, the interior cylindrical shell and its primary/secondary exchanger according to the invention can be manufactured at a factory, transported to a site and then used throughout the life of the reactor. When the time comes to dismantle it, such a circuit may be loaded in its entirety into a shipping cask so that it can be processed at a suitable facility. In other words, the invention makes it possible to drastically simplify the manufacture, deployment and dismantling of a small and medium power molten salt fast neutron nuclear reactor.
the possibility of using the one same primary-circuit architecture with an identical reactor vessel, with only the shells and neutron reflectors needing to be adapted, to suit different molten salt fuel liquids, and therefore benefiting from the versatility offered by molten salt fast neutron reactor technology.

Other advantages and features of the invention will become more clearly apparent upon reading the detailed description of exemplary implementations of the invention, given by way of non-limiting illustration with reference to the following figures.

### BRIEF DESCRIPTION OF THE DRAWINGS

FIG. 1 is a view derived from a simulation combining numerical fluid mechanics (CFD) and 3D neutron modelling showing the circulation of the primary fluid with the range of temperatures within a molten salt nuclear reactor of the fast neutron reactor type according to the invention.

FIG. 2 is a schematic view in longitudinal section illustrating a bayonet-tube exchanger, with its inlet and outlet manifolds, such as it may be arranged in a reactor according to the invention.

FIG. 3 is a view derived from a numerical simulation as in FIG. 1 for a scenario simulating a reactor according to the invention in which the molten salt fuel liquid of the primary circuit is a mixture of, the proportions being molar proportions, NaCl, 25% UCl3, 9% PuCl3 by way of salts, with depleted uranium U235 in a content of 0.2%.

FIG. 4 is a view derived from a numerical simulation as in FIG. 1 for a scenario simulating a reactor according to the invention in which the molten salt fuel liquid of the primary circuit is a mixture of, the proportions being molar proportions, NaCl, 34% UCl3 by way of salts, with enriched (HALEU) uranium U235 in a content of 20%.

FIG. 5 is a schematic view in longitudinal section of a molten salt fast neutron nuclear reactor according to the invention, showing the primary, secondary and tertiary circuits.

### DETAILED DESCRIPTION

Throughout the present application, the terms “vertical”, “lower”, “upper”, “bottom”, “top”, “below” and “above” are to be understood with reference to a molten salt fast neutron nuclear reactor in its intended vertical configuration of operation according to the invention.

A “primary fluid”, “secondary fluid”, “tertiary fluid” means the fluid respectively making up the primary, secondary and tertiary circuits.

It is emphasized that the various temperatures, powers, volumes, flow rates, etc. indicated are given solely by way of indication. For example, other temperatures may be envisioned depending on the configuration, notably depending on the power of the molten salt reactor, on the volume of molten salt fuel liquid, on the power requirement for the envisioned application, etc.

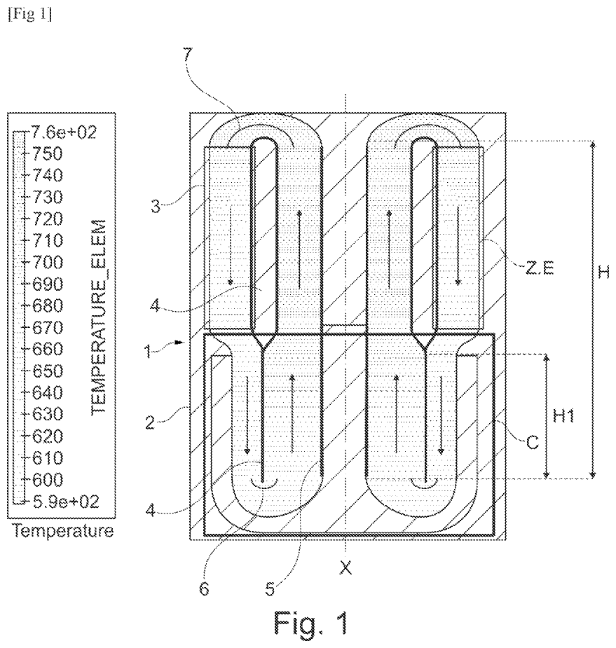

A molten salt nuclear reactor 1 of the fast neutron reactor type with a primary-circuit configuration according to one embodiment of the invention is described with reference to FIG. 1. This FIG. 1 is a view of a numerical simulation obtained by combining numerical fluid mechanics (Computational Fluid Dynamics, or CFD) with 3D neutron modelling, as explained below.

The reactor 1 of central axis X comprises a vessel 2 having a stainless steel metal barrel preferably of a thickness of the order of 10 to 20 mm, and made up of a hemispherical vessel bottom and a vertical cylinder.

This reactor vessel 2 internally delimits a primary circuit for fuel in liquid form inside which vessel at least one salt is melted. The inside of the vessel 2 is free of any moderator material. In other words, the molten salt fuel liquid fills and circulates inside the vessel without being moderated.

A single heat exchanger 3 exchanging heat between the primary reactor circuit and a secondary circuit is arranged inside the reactor vessel 2.

A first shell 4 of central axis coincident with that of the reactor vessel is arranged in the reactor vessel 2 in order to divide the interior thereof into a central zone and a peripheral zone in which the heat exchanger 3 is arranged.

In this configuration of FIG. 1, the shell 4 is made up of an upper part 40 facing the exchange zone ZE, which is in the form of a cylinder ring closed on itself, and of a lower part 41 facing the core C, which is in the form of a hollow cylinder.

By way of example, for a total height H equal to 2.5 m, the height Hl of the lower part 41 of the shell 4 is equal to 1 m.

A second shell 5 is arranged concentrically inside the first shell 4. The inside of the second shell 5 defines a space inside which nuclear-reaction control and/or safety rods may extend.

The shells 4, 5 may be made of a stainless steel or of a nickel-based alloy.

The shells 4, 5 are advantageously fixed by being suspended from the core head plug that closes the reactor vessel 2.

At the bottom of the reactor vessel 2, below the first shell 4, there is a first deflector 6 in the form of a portion of a torus.

At the top of the reactor vessel 2, above the first shell 4, there is a second deflector 7, likewise in the form of a portion of a torus.

As symbolized by the arrows in FIG. 1, with the shells 4, 5 and the deflectors 6, 7 arranged as indicated, when the reactor is in operation, the molten salt fuel liquid circulates solely via natural convection in a loop from the bottom of the central zone defining the reactor core C in which the fission reactions occur, from where it rises, as a result of heating, as far as the top of the central zone between the shells 4 and 5 where it is deflected by the deflector 7 towards the top of the peripheral zone to pass through the exchanger 3 then drops back down towards the bottom of the peripheral zone where it is deflected by the deflector 7 towards the reactor core C.

The shell 5 makes it possible to guide the fuel liquid that rises up between the two zones at which it is deflected, which is to say in the central zone of the reactor from the zone at which it is deflected by the deflector 6, passing through the core C as far as the zone at which it is deflected by the deflector 7.

Through their shapes and arrangements the deflectors 6, 7 each make it possible to distribute the flow of the deflected molten salt fuel liquid.

A neutron reflector 21 made of silicon carbide is arranged at the periphery of the core C against the reactor vessel 2.

The configuration of FIG. 1 is dedicated to a molten salt fuel liquid of the primary circuit that is a mixture of NaCl—UCl3, preferably in proportions ranging from 25 to 30 mol %, and of PuCl3, preferably in proportions ranging from 9 to 11 mol %, by way of salts, with natural uranium.

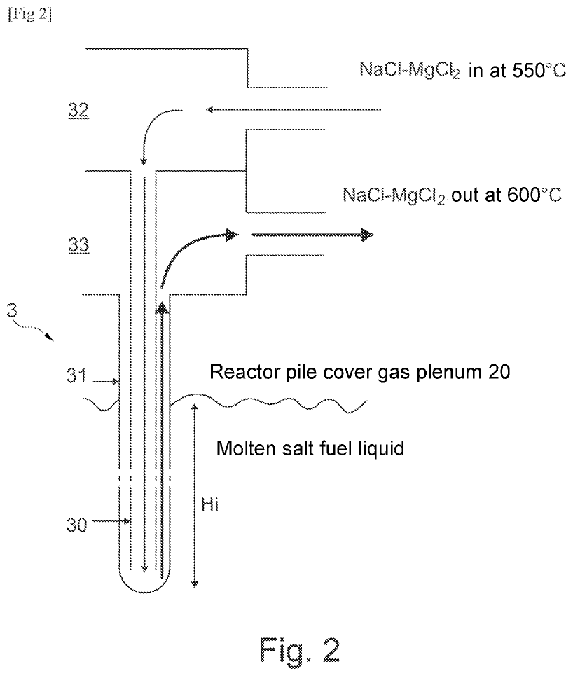

As illustrated in FIG. 2, the reactor vessel 2 comprises a cover gas plenum, usually termed a reactor pile cover gas plenum 20, filled with an inert gas, such as argon, on top of the molten salt fuel liquid.

The single heat exchanger 3 comprises a bundle of bayonet tubes defining the part for exchange with the secondary circuit.

As illustrated in FIG. 2, each bayonet tube comprises a hollow tube 30 each tube opening into a blind tube 31.

Each tube 30, 31 is plunged substantially vertically into the molten salt fuel liquid over an immersion part height Hi.

Each open-ended hollow tube 30 is connected to an inlet manifold 32 whereas each blind tube is connected to an outlet manifold 33 for the secondary fluid.

The inlet manifold 32 and outlet manifold 33 for the secondary fluid are advantageously arranged in the reactor pile cover gas plenum 20.

The inventors have performed simulations of the dimensioning of a reactor 1 like the one shown in FIG. 1.

For a given composition of salt, the inventors adapted the methodology used to design the primary circuit of this type, as follows:
Step i/: determine the minimum and maximum acceptable temperatures for the fuel liquid molten salt. The minimum temperature is generally imposed for the purpose of limiting the risk of the salt solidifying, while the maximum temperature is imposed by the maximum permissible temperatures for the materials.
Step ii/: Using the envisioned thermal power of the reactor 1, determine the primary circuit flow rate needed in order to adhere to the temperature range imposed in step i/.
Step iii/: For an envisioned primary circuit height, imposed for example by constraints on the transportability of the reactor vessel 2, determine the cross sections of horizontal passages in the core C and the exchanger 3 that are needed in order to obtain the primary circuit flow rate envisioned in step ii/.
Step iv/: Since the horizontal cross section of the core C is known, determine the height of core C needed in order to ensure its criticality. For cores of high power, i.e. of large cross section, a reduced height may prove to be sufficient. By contrast, a low demanded power may lead to a core of more elongated shape.

In practice, the inventors have performed pre-dimensioning calculations on the primary circuit of a reactor such as shown in FIG. 1 using numerical-simulation tools that combine thermal-hydraulic CFD modelling, for determining the local velocity and temperature ranges, with 3D neutron modelling, for determining the attainment of criticality and the spatial distribution of the power.

The CFD numerical simulation software may be that known by the name of TrioCFD. This TrioCFD code was developed by the Applicant and validated for effectively dealing with various physical problems such as turbulent flow, fluid/solid interactions, polyphasic flows or flows in a porous environment: [3].

The 3D neutron modelling software may be that known by the name of ERANOS. This ERANOS software package was developed and validated with a view to providing a suitable basis for reliable neutronic calculations for existing or future advanced fast neutron reactor cores: [4].

The ERANOS software package was used with the European JEFF3.1.1 Nuclear Data Library provided by the Nuclear Energy Agency NEA.

Publication [5] is an example of a benchmark achieved by combining thermal-hydraulic CFD modelling with 3D neutron modelling.

Multiple iterations are needed in order to arrive at an optimal design.

The dimensional, temperature, power and molten salt fuel liquid characteristics obtained are as follows:
power: 150 MWth;
primary circuit operating temperature: between 600 and 750° C.;
primary circuit molten salt fuel liquid to be selected from: a mixture of NaCl—UCl₃, in proportions ranging from 25 to 30 mol %, and of PuCl₃, in proportions ranging from 9 to 11 mol %, with 0.7% natural uranium, or a mixture of NaCl—UCl₃, in a proportion of 34 mol %, with 20% enriched uranium U235;
pressure inside the reactor vessel 2: atmospheric pressure.

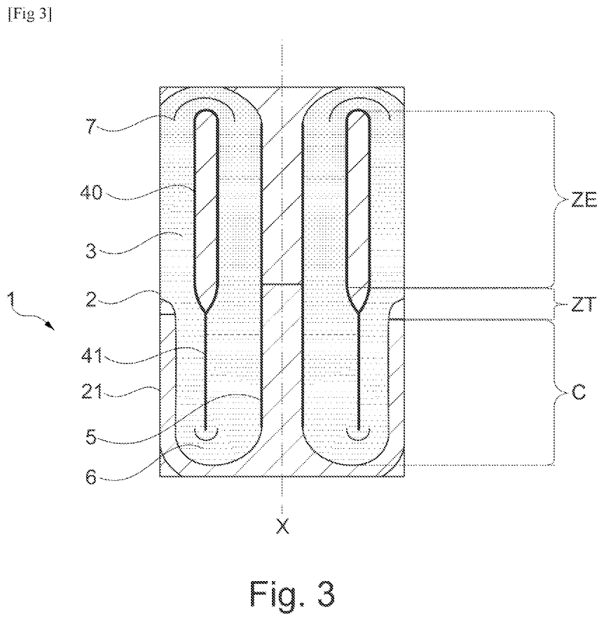

FIG. 3 illustrates the scenario of a reactor 1 obtained using the aforementioned combined numerical simulation, for a fuel liquid containing a mixture of NaCl-25% UCl3-9% PuCl3 salts with 0.7% depleted uranium. The neutron reflector is made of SiC.

In this scenario, the data obtained are as follows:
inside diameter of the reactor vessel 2: equal to 1.78 m;
outside diameter of the reactor vessel 2: equal to 1.8 m;
height of the reactor vessel 2: equal to 2.5 m;
height of core C: equal to 0.8 m;
height of exchange zone ZE: equal to 1.5 m;
height of transition zone ZT, between the exchange zone ZE and the core C: equal to 0.2 m;
inside diameter of the ring 40 of the shell 4: equal to 0.89 m;
outside diameter of the ring 40 of the shell 4: equal to 1.22 m;
thickness of the hollow cylinder 41 of the shell 4: equal to 0.05 m;
inside diameter of the exchanger 3: equal to 1.22 m;
outside diameter of the exchanger 3: equal to 1.78 m;
thickness of the neutron reflector: equal to 0.145 m;
outside diameter of the shell 5: equal to 0.32 m;
flow rate of fuel liquid within the core: equal to 1856 kg/s with a temperature difference between the inlet and outlet of the core C: equal to 140° C.;
effective neutron multiplication factor keff, which expresses the factor by which the number of fissions is multiplied from one generation of neutrons to the next: equal to 1.005+/−0.2;
τconv: equal to 1.01.

It will be recalled here that τconv denotes the conversion ratio which is calculated using the following methodology:
by determining, for each possible isotope of U and of Pu, its contribution to the chain reaction and expressing it as its Pu-239 equivalent. For example, a U-235 nucleus has the same value as approximately 0.7 of a Pu-239 nucleus, while a Pu-241 nucleus has the same value as approximately 2.0 of them;
by assessing the production of these isotopes against the destruction thereof in order to calculate the ratio between the number of Pu-239-equivalent nuclei produced and the number of Pu-239-equivalent nuclei destroyed.

Reference may be made to publication [6] which explains this methodology in detail.

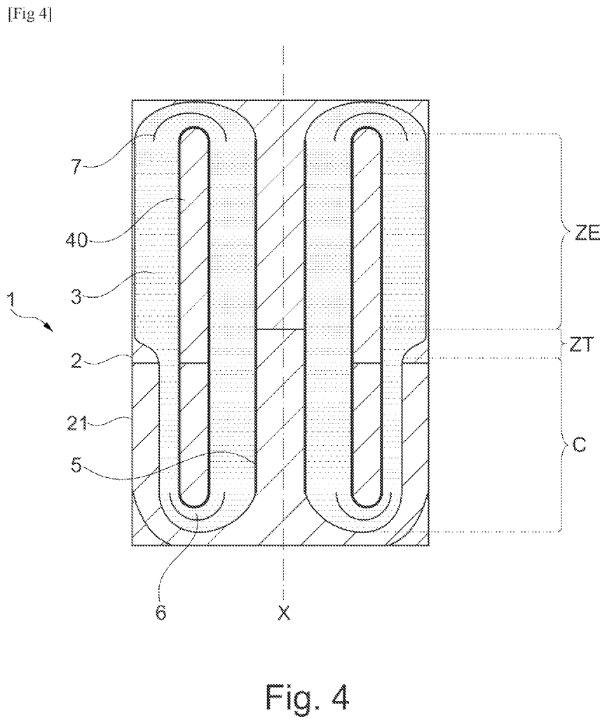

FIG. 4 illustrates the scenario of a reactor 1 obtained using the aforementioned combined numerical simulation, for a fuel liquid containing a mixture of 34 mol % NaCl—UCl₃ with 20% enriched uranium U235. The neutron reflector is made of graphite.

In this scenario, the data obtained are as follows:
inside diameter of the reactor vessel 2: equal to 1.78 m;
outside diameter of the reactor vessel 2: equal to 1.8 m;
height of the reactor vessel 2: equal to 2.5 m;
height of core C: equal to 0.8 m;
height of exchange zone ZE: equal to 1.5 m;
height of transition zone ZT, between the exchange zone ZE and the core C: equal to 0.2 m;
inside diameter of the ring 40 of the shell 4: equal to 0.89 m;
outside diameter of the ring 40 of the shell 4: equal to 1.22 m;
inside diameter of the exchanger 3: equal to 1.22 m;
outside diameter of the exchanger 3: equal to 1.78 m;
thickness of the neutron reflector: equal to 0.145 m;
outside diameter of the shell 5: equal to 0.32 m;
flow rate of fuel liquid within the core: equal to 1750 kg/s with a temperature difference between the inlet and outlet of the core C: equal to 150° C.;
effective neutron multiplication factor keff: equal to 1.008+/−0.2;
τconv: equal to 0.95.

All the components (vessels 2, shells 4, 5, exchanger 3) are made from a stainless steel for the configurations of FIGS. 3 and 4.

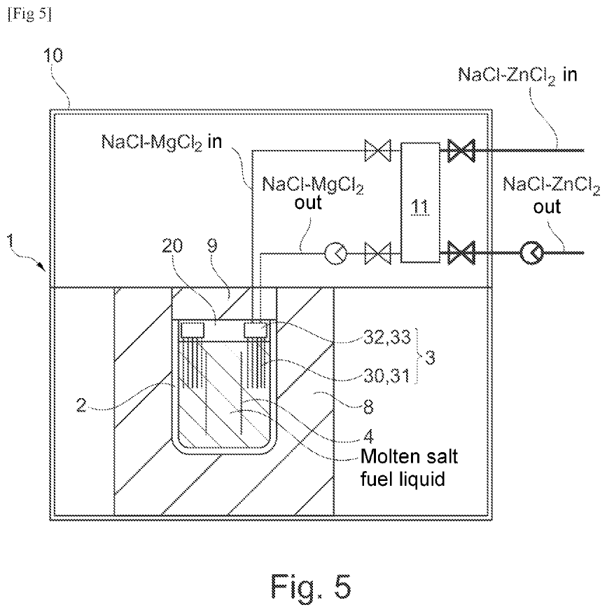

FIG. 5 illustrates an example of the integration of the reactor 1 which has just been described into a reactor building 10 and the secondary and tertiary circuits.

The secondary fluid consists of a mixture of NaCl—MgCl₂ salts which by forced convection enters the exchanger 3 at 550° C. and exits same at 600° C.

The exchanger 11 between the secondary and tertiary circuits is housed within the reactor building 10.

The tertiary fluid consists of a mixture of NaCl—ZnCl₂ salts which by forced convection enters the exchanger 11 at 500° C. and exits same at 550° C.

The invention is not limited to the examples that have just been described; it is in particular possible to combine features of the illustrated examples with one another in variants that have not been illustrated.

Other variants and embodiments may be contemplated without however departing from the scope of the invention.

### LIST OF CITED REFERENCES

[1]: E. Merle-Lucotte, M. Allibert, M. Brovchenko, D. Heuer, V. Ghetta, A. Laureau, P. Rubiolo, the chapter entitled “Introduction to the Physics of Thorium Molten Salt Fast Reactor (MSFR) Concepts”, Thorium Energy for the World, Springer International Publishing, Switzerland (2016).
[2]: Jiri Krepel et al. “Self-Sustaining Breeding in Advanced Reactors: Characterization of Selected Reactors”, Encyclopedia of Nuclear Energy 2021, Pages 801-819. https://www.sciencedirect.com/science/article/pii/B9780128197257001239?via%3Dihub
[3]: Pierre-Emmanuel Angeli et al. “OVERVIEW OF THE TRIOCFD CODE: MAIN FEATURES, V&V PROCEDURES AND TYPICAL APPLICATIONS TO NUCLEAR ENGINEERING”. NURETH-16, Chicago, IL, Aug. 30-Sep. 4, 2015.
[4]: G. Rimpault, et al. “The ERANOS Code and data system for fast reactor neutronic analyses.” PHYSOR2002-International Conference on the New Frontiers of Nuclear Technology: Reactor Physics, Safety and High-Performance Computing, October 2002, Seoul, South Korea.
[5]: Marco Tiberga et al. “Results from a multi-physics numerical benchmark for codes dedicated to molten salt fast reactors”, Annals of Nuclear Energy 142 (2020) 107428.
[6]: A. R. Baker, R. W. Ross, “Comparison of the value of plutonium and uranium isotopes in fast reactors.” In Proc. Conf. Breeding, Economics and Safety in Large Fast Breeder Reactors (Argonne National Laboratory, 1963), pp. 329-364, ANL-6792.

1. A molten salt nuclear reactor of a fast neutron reactor type, comprising:
a reactor vessel exhibiting symmetry of revolution about a central axis, internally delimiting a primary circuit for fuel in liquid form and in which vessel at least one salt is melted, and inside of the vessel being free of a moderator material;
a heat exchanger configured to exchange heat between the primary reactor circuit and a secondary circuit and arranged inside the reactor vessel;
a first shell formed as at least one hollow cylinder of central axis coincident with that of the reactor vessel, the first shell being arranged in the reactor vessel so as to divide the interior thereof into a central zone and a peripheral zone in which the heat exchanger is arranged so that when the reactor is in operation, molten salt fuel liquid circulates via natural convection in a loop from a bottom of the central zone defining a reactor core in which the fission reactions occur, from where it rises, as a result of heating, as far as a top of the central zone where it is deflected towards the top of the peripheral zone to pass through the heat exchanger then drops back down towards the bottom of the peripheral zone where it is deflected towards the reactor core;
a neutron reflector, arranged at the periphery of the reactor core against the reactor vessel, configured to maintain neutron flux in the reactor core.

2. The reactor of claim 1,
wherein the molten salt fuel liquid of the primary circuit is a mixture of NaCl—UCl₃, and of PuCl3, with depleted uranium,
wherein a first part of the first shell that is arranged above the heat exchanger(s) is a cylinder ring closed on itself, while a second part that is arranged below the heat exchanger(s) is a hollow cylinder,
wherein the neutron reflector is made of silicon carbide (SIC).

3. The reactor of claim 1,
wherein the molten salt fuel liquid of the primary circuit is a mixture of NaCl—UCl₃ with enriched (HALEU) uranium U235,
wherein the first shell is a cylinder ring closed on itself,
wherein the neutron reflector is graphite.

4. The reactor of claim 1, further comprising:
a second shell arranged concentrically inside the first shell so as to guide the rising fuel liquid between the two zones at which it is deflected.

5. The reactor of claim 4, wherein an inside of the second shell defines a space inside which nuclear-reaction control and/or safety rods extend.

6. The reactor of claim 1, wherein a diameter of the reactor vessel is in a range of from 1.5 to 2 m.

7. The reactor of claim 1, wherein a height of the primary circuit inside the reactor vessel is in a range of from 2.5 to 4 m.

8. The reactor of claim 1, configured to maintain a temperature of the molten salt fuel liquid of the primary circuit in a range of from 500 to 900° C. when the reactor is in operation.

9. The reactor of claim 1, wherein a secondary fluid circulating in the heat exchanger(s) comprises NaCl—MgCl₂ or NaCl—MgCl₂—KCl or NaCl—MgCl₂—KCl—ZnCl₂ in molten form.

10. The reactor of claim 9, configured to maintain an entry temperature of the secondary fluid entering the heat exchanger(s) of 550° C., and an exit temperature on leaving the heat exchanger(s) of 600° C.

11. The reactor of claim 1, having a power of less than 300 MWth.

12. The reactor of claim 2, wherein the mixture of NaCl—UCl₃ and PuCl₃ comprises the UCl₃ in a range of from 25 to 30 mol %, based on its salt.

13. The reactor of claim 2, wherein the mixture of NaCl—UCl₃ and PuCl₃ comprises the PuCl₃ in a range of from 5 to 36 mol %, based on its salt.

14. The reactor of claim 2, wherein the mixture of NaCl—UCl₃ and PuCl₃ comprises, based on salts,
the UCl₃ in a range of from 25 to 30 mol %, and
the PuCl₃ in a range of from 5 to 36 mol %.

15. The reactor of claim 3, wherein the NaCl—UCl₃ is present in the molten salt fuel liquid in 34 mol %, by salt.

16. The reactor of claim 3, wherein the enriched (HALEU) uranium U235 is present in the molten salt fuel liquid in a range of from 5 to 20%.

17. The reactor of claim 3, wherein, in the molten salt fuel liquid,
the NaCl—UCl₃ is present in 34 mol %, by salt, and
the enriched (HALEU) uranium U235 is present in a range of from 5 to 20%.
